(19) United States
(12) Patent Application Publication
(10) Pub. No.: US 2005/0289349 A1
(43) Pub. Date: Dec. 29, 2005

(54) Method for generating and/or validating electronic signatures

(75) Inventors: Markus Franke, Freising (DE); Andreas Furch, Freising (DE); Markus Heintel, Munchen (DE); Oliver Pfaff, Berlin (DE)

Correspondence Address: Siemens Corporation;Intellectual Property Department, 170 Wood Avenue South, Iselin, NJ, 08830, US

(73) Assignee: SIEMENS AKTIENGESELLSCHAFT, GERMANY (DE)

(21) Appl. No.: 10/528,312

(22) PCT Filed: Sep. 17, 2003
(86) PCT No.: PCT/EP03/10327

§ 371 Date: Mar. 17, 2005

(30) Foreign Application Priority Data
Sep. 17, 2002 (EP) 02020818.7

(51) Int. Cl. H04L 9/00

(52) U.S. Cl. 713/176

(57) ABSTRACT

The invention relates to a method for generating and/or validating electronic signatures during which an asymmetric key pair is generated that comprises a private signature key and a public validation key. In addition, at least one electronic signature is calculated by using the private signature key and by applying a predeterminable signature function for at least one electronic document. A certification of the public validation key ensues after the calculation of the at least one electronic signature.

### CROSS REFERENCE TO RELATED APPLICATIONS

This application is the U.S. National Stage of International Application No. PCT/EP2003/010327, filed Sep. 17, 2003 and claims the benefit thereof. The International Application claims the benefits of European application No. 02020818.7 filed Sep. 17, 2002, both applications are incorporated by reference herein in their entirety.

### FIELD OF THE INVENTION

The invention relates to a method for generating and/or validating electronic signatures.

### BACKGROUND OF THE INVENTION

Electronic signatures are used in order to meet security aims such as authenticity, legal validity and integrity. In cases where electronic data can be interpreted as a declaration of intent, a positive result from a verification of an electronic signature serves as a form of evidence for its legal effectiveness. Electronic signatures work with two keys which are generated together and are mathematically dependent on each other. One of these keys—subsequently called the private key—is kept secret and can be used for generating an electronic signature. The other key—subsequently called the public key—is published and can be used for verifying a signature which has been provided. In order to assign electronic signatures to people, it is necessary to have a link between the name of a person and the corresponding public key. This link takes the form of a special electronic document, which is issued by a trusted third party and is called a certificate.

In technical terms, certificates are data structures which contain information whereby a link is established between public keys and key holders. The actual link between a public key and a specific key holder is established by a trusted and neutral certification authority (CA) which certifies the associated complete certificate by means of its electronic signature. Certificates only have a limited period of validity, which is likewise signed by the certification authority as part of the certificate.

The certification authority assumes responsibility for the verification of the name, and links the name of the person to the public key of this person by means of an electronic signature (using its private key). The result of the certification of a public key is a certificate. The standard X.509 is used as a certificate structure. In addition to the public key, such a certificate includes the name of the issuing certification authority, a period of validity, the name of the owner and a unique number of the issuing certification authority. In this context, it is presupposed that all participants trust the public key of this certification authority. Certification authorities have separate key pairs for the signing of certificates, black lists and time stamps, and for processing communications with other communication partners.

Known signature methods consist of an algorithm for generating electronic signatures and an associated algorithm for verifying electronic signatures. The electronic data for which an electronic signature was formed is usually appended as an attachment to the electronically signed data. Each algorithm for generating electronic signatures includes as input parameters at least data which must be signed and a private key of a signatory, and outputs an electronic signature as a result. The associated algorithm for verifying electronic signatures contains as input parameters at least electronically signed data and a public key of a signatory, and outputs a positive or negative verification result, depending on whether the verification was successful.

Until now, generation of electronic signatures has taken place according to the following sequence:
generating an asymmetric key pair comprising a private key and a public key,
issuing a certificate for the public key,
determining a hash value for the data which must be signed,
calculating the electronic signature by applying a predetermined signature function,
outputting the electronic signature.

Until now, a verification of electronic signatures has taken place according to the following sequence:
determining a hash value for the electronic data from the attachment to the electronic signature,
applying a predetermined verification function to the electronic signature and the hash value,
outputting the verification result.

Signature methods differ by virtue of the signature and verification function that is used (e.g. RSA, DSA or ECDSA), a hash algorithm that is used for determining the hash value (e.g. SHA-1 or RIPEMD-160), and a padding method that might be used (in the case of RSA). A padding method is applied in order to expand a hash value by means of a character string, which can be predetermined, if it is necessary to adapt the length of the hash value.

### SUMMARY OF THE INVENTION

All previously known signature methods require significant effort for the permanent protection of the private signature key, by the person to whom the private signature key is assigned, against unauthorized access.

The present invention addresses the problem of creating a method for generating electronic signatures, which method does not require permanent protection of a private signature key, by a person to whom the private signature key is assigned, against unauthorized access.

This problem is solved by the claims. Advantageous developments of the method according to the invention are specified in the dependent claims.

An essential aspect of the present invention is that a certification of a public validation key does not take place until after a calculation of an electronic signature. An intentional action by an author of an electronic document, said action being expressed by means of a signed document, therefore only takes place after signature generation in the context of a certificate request process. Because the intentional action is represented by a certificate request instead of an initiation of a calculation of an electronic signature, it is not necessary to keep a private signature key, which corresponds to the public validation key, after calculation of the electronic signature. Consequently, the private signature key can be destroyed following calculation of the electronic signature, and therefore no longer needs to be protected against unauthorized access.

### BRIEF DESCRIPTION OF THE DRAWINGS

The present invention is explained in greater detail below on the basis of an exemplary embodiment and with reference to the drawing, in which

FIG. 1 shows an illustration of an execution of a conventional signature method,

FIG. 2 shows an illustration of an execution of a signature method according to the invention.

### DETAILED DESCRIPTION OF THE INVENTION

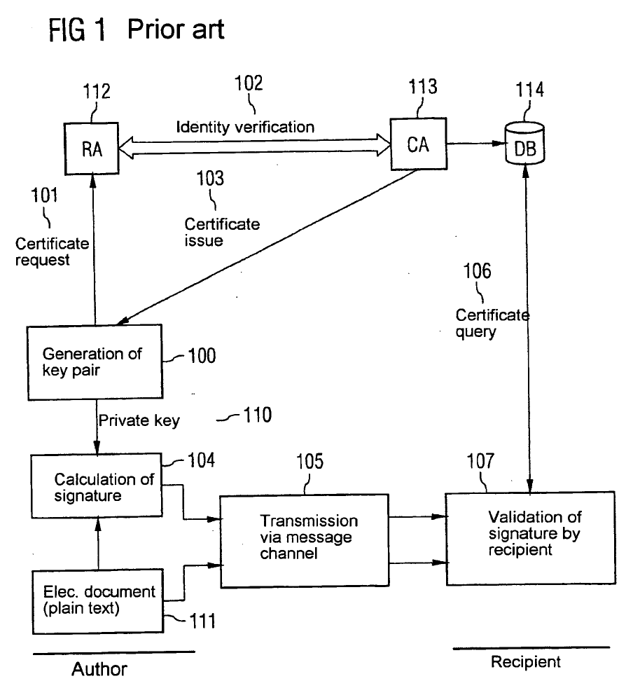

FIG. 1 illustrates an execution of a conventional signature method, in which firstly a key pair is generated, said key pair comprising a private signature key 110 and a public validation key (step 100). A certificate request is then submitted (step 101) to a registration authority 112 (RA). As part of the coordinated activity between the registration authority 112 and a certification authority 113 (CA), an identity verification is performed in relation to a relevant applicant (step 102).

In the case of a positive verification result, the certification authority 113 awards a certificate for the public validation key to a relevant applicant (step 103) and stores a corresponding entry for the issued certificate in a database 114 which has been assigned to the certification authority 113, said database 114 being publicly accessible for certificate queries. Certificate black lists which identify invalid certificates are also stored in the database 114. After certification of the public validation key, an electronic signature is calculated for a document 111 which has to be signed, using the private signature key 110 and a predeterminable signature function (step 104). Finally, the calculated signature and the electronic document 111 are transmitted via a message channel from the author of the electronic document 111 as a message to a recipient of the electronic document 111 (step 105).

On the recipient side, a certificate query is then performed (step 106) in order to validate the electronic signature. In this case, either the database 114 is queried in respect of a public validation key which has been assigned to the author, or the database 114 is queried in respect of an entry which is assigned to the public validation key that is contained in the transmitted message, said entry confirming the validity of the assigned certificate if applicable. Finally, a validation of the signature which is contained in the transmitted message is performed by the recipient (step 107). The validation of the electronic signature by the recipient includes both decrypting the signature with the aid of the public validation key, and calculating a hash value for the electronic document 111. Lastly, the decrypted signature and the calculated hash value are compared for agreement. If the decrypted signature and the calculated hash value agree, the signature is recognized as valid on the recipient side.

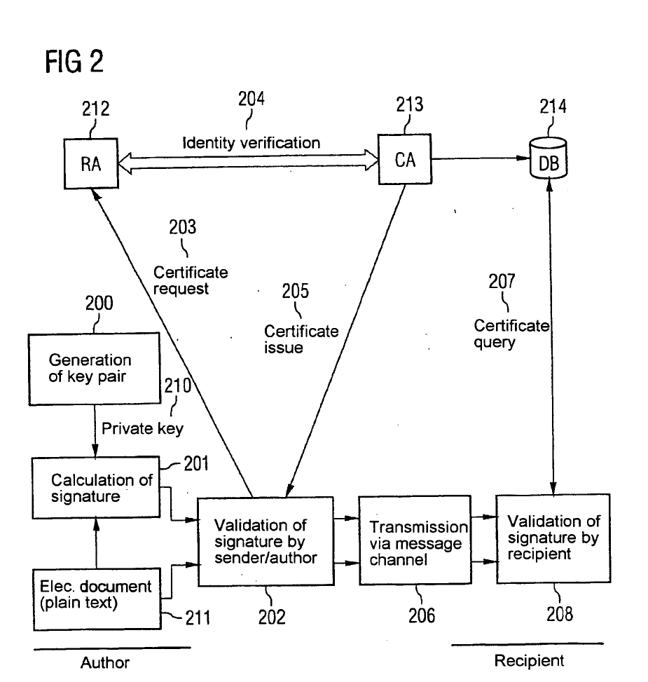

FIG. 2 illustrates an execution of a signature method according to the invention, in which firstly an asymmetrical key pair is generated (step 200). Using a private signature key 210 which is included in the generated key pair and a predeterminable signature function, an electronic signature is calculated from an electronic document 211 on the author side (step 201). Following calculation of the electronic signature, this is validated by the author in order to ensure that the calculated electronic signature corresponds to an action of intent which is expressed by the electronic document 111 (step 202).

In the case of a positive validation result, a certificate for a public validation key corresponding to the private signature key 210 is requested from a registration authority 212 (step 203). Details which are contained in the certificate request are then verified, in particular the identity of the author or of an applicant (step 204).

In the case of a positive verification result, a certification authority 213 issues a certificate for the public validation key to the applicant or author of the electronic document 211 (step 205). In addition, a corresponding entry for the issued certificate is made in a database which has been assigned to the certification authority 213.

After validation of the calculated signature by the author of the electronic document 211 and after certification of the public validation key, the electronic document 211 and the calculated electronic signature are transmitted to a recipient of the electronic document 211 as a message via a message channel (step 206). On the recipient side, a certificate query is performed in a known manner (step 207) and a validation of the signature which is contained in the received message is carried out (step 208).

When validating an electronic signature, only those signatures which were generated at a time prior to the certification of the public validation key are recognized as valid. This has the result of eliminating the revocation problems which relate to public validation keys and are known in the context of previous signature methods. Moreover, this ensures that it is no longer possible to misuse the private signature key after the time of the certification of the public validation key, and therefore no mechanisms for permanently preventing unauthorized accesses to the private signature key 210 are required.

When certifying the public validation key in accordance with the steps 203 to 205, it is possible to include a reference to the relevant signed electronic document 211 in addition to a user identifier and the public validation key. When validating the signature on the recipient side in accordance with step 208, the reference to the electronic document 211 is then also evaluated. Furthermore, it is possible for the certification of the public validation key to include not just one reference to a single electronic document, but a plurality of references to electronic documents which are signed within a specific reference period. A reference to an electronic document is implemented, for example, by means of a calculation of a hash value for the relevant electronic document. When validating the signature on the recipient side in accordance with step 208, the corresponding hash values are then compared with each other.

An application of the signature method according to the invention is possible within a central hardware security module, for example. In this context, a private signature key in the central hardware security module is jointly available to all members of a closed user group. On the user side, hash values for electronic documents which must be signed are generated and transferred to the hardware security module via a secure transmission channel. The hardware security module calculates the electronic signature without further verification and sends it back to a relevant user. The relevant user stores the signed electronic document, together with its associated hash value and electronic signature, following successful validation of the signature by the relevant user. The associated hash values are subsequently appended to the certificate request for the public validation key, and are included in the certificate for the public validation key by the certification authority as an additional attribute. The certificate is therefore linked to the signed electronic document in a unique manner.

Instead of using a central hardware security module, it is also possible to use a personal security module for signature generation. In this case, the hash value for the electronic document which must be signed is generated on a personal computer or similar and transferred to the personal security module via an infrared or Bluetooth interface, for example.

A further application of the signature method according to the invention consists of using a printer which has been modified and is equipped with validation logic. As input parameters, such a validation printer receives an electronic document which must be signed and an electronic signature which has been calculated for this electronic document. If the validation of the electronic signature is successful, the associated electronic document is output on the validation printer. The author of the electronic document is then given the possibility of deciding, on the basis of the printout, whether said author wishes to allow the certification of the previously used private signature key.

The application of the present invention is not restricted to the exemplary embodiments which are described here.

1-5. (canceled)

6. A method for generating and/or validating electronic signatures, the method comprising:
generating an asymmetrical key pair which includes a private signature key and a public validation key;
calculating an electronic signature for an electronic document by means of the private signature key and by applying a predeterminable signature function; and
performing a certification of the public validation key.

7. The method according to claim 6, wherein, when validating, only those signatures which are and/or were generated at a time prior to the certification of the public validation key are recognized as valid.

8. The method according to claim 6, wherein, when certifying the public validation key, a reference to the electronic document is included in addition to a user identifier and the public validation key.

9. The method according to claim 7, wherein, when certifying the public validation key, a reference to the electronic document is included in addition to a user identifier and the public validation key.

10. The method according to claim 8, wherein an implementation of the reference is performed by a calculation of a hash value for the electronic document.

11. The method according to claim 9, wherein an implementation of the reference is performed by a calculation of a hash value for the electronic document.

12. The method according to claim 6, wherein, following calculation of the signature and prior to its transfer to a recipient, a validation is performed by an author of the electronic document, in order to verify an action of intent which is expressed by the electronic document.

13. The method according to claim 7, wherein, following calculation of the signature and prior to its transfer to a recipient, a validation is performed by an author of the electronic document, in order to verify an action of intent which is expressed by the electronic document.

14. The method according to claim 8, wherein, following calculation of the signature and prior to its transfer to a recipient, a validation is performed by an author of the electronic document, in order to verify an action of intent which is expressed by the electronic document.

15. The method according to claim 9, wherein, following calculation of the signature and prior to its transfer to a recipient, a validation is performed by an author of the electronic document, in order to verify an action of intent which is expressed by the electronic document.

16. The method according to claim 10, wherein, following calculation of the signature and prior to its transfer to a recipient, a validation is performed by an author of the electronic document, in order to verify an action of intent which is expressed by the electronic document.

17. The method according to claim 10, wherein, following calculation of the signature and prior to its transfer to a recipient, a validation is performed by an author of the electronic document, in order to verify an action of intent which is expressed by the electronic document.

18. A method for generating and/or validating electronic signatures, the method comprising:
generating an asymmetrical key pair which includes a private signature key and a public validation key;
calculating at least one electronic signature for at least one electronic document by means of the private signature key and by applying a predeterminable signature function; and
following calculation of the electronic signature, of which there is at least one, carrying out a certification of the public validation key.

19. The method according to claim 18, wherein, when validating, only those signatures which are and/or were generated at a time prior to the certification of the public validation key are recognized as valid.

20. The method according to claim 18, wherein, when certifying the public validation key, at least one reference to the electronic document, of which there is at least one, is included in addition to a user identifier and the public validation key.

21. The method according to claim 19, wherein, when certifying the public validation key, at least one reference to the electronic document, of which there is at least one, is included in addition to a user identifier and the public validation key.

22. The method according to claim 20, wherein an implementation of the reference, of which there is at least one, takes place by means of a calculation of a hash value for the electronic document, of which there is at least one.

23. The method according to claim 18, wherein, following calculation of the signature and prior to its transfer to a recipient, a validation is performed by an author of the electronic document, of which there is at least one, in order to verify an action of intent which is expressed by the electronic document, of which there is at least one.
